(19) United States
(12) Patent Application Publication
(10) Pub. No.: US 2012/0063689 A1
(43) Pub. Date: Mar. 15, 2012

(54) OBJECT RECOGNITION IN AN IMAGE

(75) Inventors: Trac D. Tran, Columbia, MD (US); Chen Yi, Baltimore, MD (US); Thong T. Do, Silver Spring, MD (US)

(73) Assignee: The Johns Hopkins University, Baltimore, MD (US)

(21) Appl. No.: 13/233,750

(22) Filed: Sep. 15, 2011

Related U.S. Application Data
(60) Provisional application No. 61/383,146, filed on Sep. 15, 2010.

(51) Int. Cl. G06K 9/46

(52) U.S. Cl. 382/224

(57) ABSTRACT

A method of identifying an object in an image includes selecting a portion of a target image of a target object, selecting a corresponding window portion of a reference image of a reference object from at least one reference image of at least one reference object, the position of the window portion within the reference image corresponding to the position of the portion of the target image within the target image, generating a reference set including a plurality of different portions of the reference image from within the window portion, determining a weighted combination of the plurality of different portions from the reference set approximating the portion of the target image, and determining whether the target object matches the reference object based on the weighted combination.

### CROSS-REFERENCE OF RELATED APPLICATION

This application claims priority to U.S. Provisional Application No. 61/383,146 filed Sep. 15, 2010, the entire contents of which are hereby incorporated by reference.

This invention was made with Government support of Grant No. CCF-0728893, awarded by the National Science Foundation. The U.S. Government has certain rights in this invention.

### BACKGROUND

1. Field of Invention

The current invention relates to object recognition in an image.

2. Discussion of Related Art

The contents of all references, including articles, published patent applications and patents referred to anywhere in this specification are hereby incorporated by reference.

Sparse representations have been recently exploited in many pattern recognition applications (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009) (J. K. Pillai, V. M. Patel, and R. Chellappa, “Sparsity inspired selection and recognition of iris images,” in Proc. IEEE Third International Conference on Biometrics: Theory, Applications and Systems, September 2009, pp. 1-6)(X. Hang and F.-X. Wu, “Sparse representation for classification of tumors using gene expression data,” Journal of Biomedicine and Biotechnology, vol. 2009, doi:10.1155/2009/403689). These approaches are based on the assumption that a test sample approximately lies in a low-dimensional subspace spanned by the training data and thus can be compactly represented by a few training samples. The recovered sparse vector then can be used directly for recognition. This approach is simple and fast since no training stage is needed and the dictionary can be easily expanded by additional training samples. The original sparsity-based face recognition algorithm (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009) yields superior recognition performance comparing to other techniques. However, the algorithm suffers from the limitation that the test face must be perfectly aligned to the training data prior to classification. To overcome this problem, various methods have been proposed for simultaneously optimizing the registration parameters and the sparse coefficients (J. Huang, X. Huang, and D. Metaxas, “Simultaneous image transformation and sparse representation recovery,” in Proc. of IEEE Conference on Computer Vision and Pattern Recognition, June 2008, pp. 1-8)(A. Wagner, J. Wright, A. Ganesh, Z. Zhou, and Y. Ma, “Towards a practical face recognition system: Robust registration and illumination by sparse representation,” in Proc. of IEEE Conference on Computer Vision and Pattern Recognition, June 2009, pp. 597-604), leading to even more complicated systems.

In many signal processing applications, local features are more representative and contain more important information than global features. One of such examples is the block-based motion estimation technique successfully employed in multiple video compression standards.

### SUMMARY

A method of identifying an object in an image according to an embodiment of the current invention includes selecting a portion of a target image of a target object, selecting a corresponding window portion of a reference image of a reference object from at least one reference image of at least one reference object, the position of the window portion within the reference image corresponding to the position of the portion of the target image within the target image, generating a reference set including a plurality of different portions of the reference image from within the window portion, determining a weighted combination of the plurality of different portions from the reference set approximating the portion of the target image, and determining whether the target object matches the reference object based on the weighted combination.

A method of modifying an image of an object according to an embodiment of the current invention includes selecting a portion of a target image of a target object, selecting a corresponding window portion of a reference image of a reference object from at least one reference image of at least one reference object, the position of the window portion within the reference image corresponding to the position of the portion of the target image within the target image, generating a reference set including a plurality of different portions of the reference image from within the window portion, determining a weighted combination of the plurality of different portions from the reference set approximating the portion of the target image, and replacing the portion of the target image with a composite image from the different portions from the reference set based on the weighted combination.

A tangible machine readable storage medium that provides instructions, which when executed by a computing platform, cause the computing platform to perform operations including a method of identifying an object in an image, according to an embodiment of the current invention, including selecting a portion of a target image of a target object, selecting a corresponding window portion of a reference image of a reference object from at least one reference image of at least one reference object, the position of the window portion within the reference image corresponding to the position of the portion of the target image within the target image, generating a reference set including a plurality of different portions of the reference image from within the window portion, determining a weighted combination of the plurality of different portions from the reference set approximating the portion of the target image, and determining whether the target object matches the reference object based on the weighted combination.

### BRIEF DESCRIPTION OF THE DRAWINGS

Further objectives and advantages will become apparent from a consideration of the description, drawings, and examples.

FIG. 1 illustrates a block diagram of a system according to an embodiment of the current invention.

FIG. 2 illustrates an exemplary target image according to an embodiment of the current invention;

FIG. 3 illustrates an exemplary reference image according to an embodiment of the current invention;

FIG. 4 illustrates an exemplary process flowchart for determining a reference object matches a target object according to an embodiment of the current invention;

FIG. 5 illustrates a diagram of how to determine a weighted combination of portions in a reference set that approximates a corresponding portion of a target image according to an embodiment of the current invention;

FIG. 6 illustrates an exemplary process flowchart for determining a target object matches a reference object based on frequency matching according to an embodiment of the current invention;

FIG. 7 illustrates an exemplary process flowchart for determining a target object matches a reference object based on probability matching according to an embodiment of the current invention;

FIG. 8 illustrates an exemplary process flowchart for modifying a target image according to an embodiment of the current invention;

FIGS. 9A-9C illustrates an exemplary method of representing a block in a test face image from a locally adaptive dictionary according to an embodiment of the current invention;

FIG. 10A-10F illustrates an exemplary method of matching using multiple blocks in a test image according to an embodiment of the current invention;

FIGS. 11A and 11B illustrate an exemplary original test image and an exemplary distorted test image according to an embodiment of the current invention;

FIG. 11C illustrates an exemplary graph of the recognition rate for each rotation degree according to an embodiment of the current invention;

FIGS. 12A and 12B illustrate another exemplary original test image and an exemplary distorted test image according to an embodiment of the current invention; and

FIG. 13 illustrates receiver operating characteristic (ROC) curves according to an embodiment of the current invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification are incorporated by reference as if each had been individually incorporated.

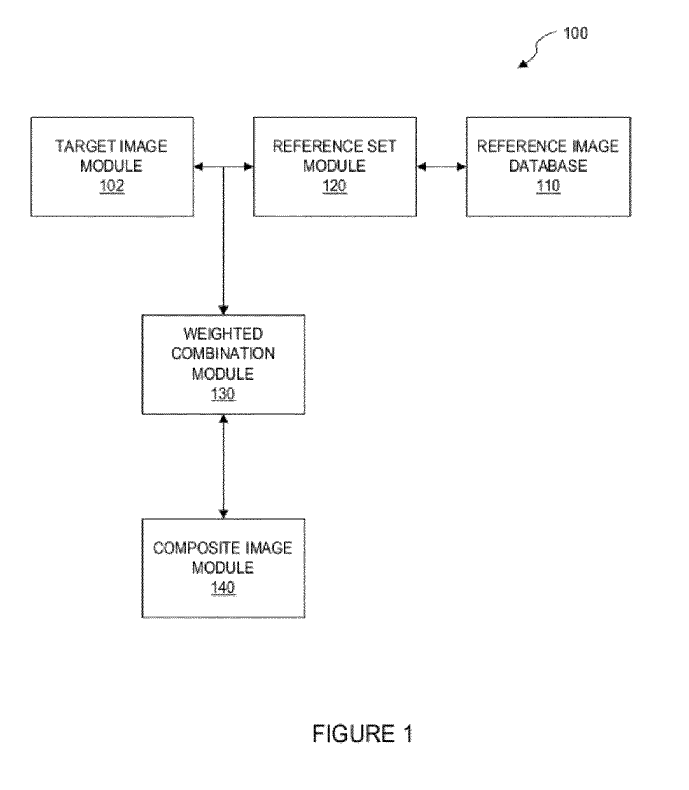

FIG. 1 illustrates a block diagram of system 100 according to an embodiment of the current invention. System 100 may include target image module 102, reference image database 110, reference set module 120, weighted combination module 130, and composite image module 140. Target image module 102 may receive a target image. A target image may be a two-dimensional or three-dimensional image of a target object. The image may be a digital image. A digital image may be a numerical representation of a two-dimensional image. The numerical representation may be a raster graphics image, or bitmap, which is a data structure representing a generally rectangular grid of pixels, or points of color. The images may be gray scale images, images in which the value of each pixel is a single sample carrying only intensity information. An example of a gray scale image is a black and white image composed of shades of gray varying from black to white. The target object may be an object to be recognized in the target image. A target object may be a face, a fingerprint, a vehicle, a building, an animal, etc. Target image module 102 may select at least one portion of the target image by which system 100 may recognize the target object.

Reference image database 110 may store one or more reference images. The reference images may be images of reference objects for which database 110 recognizes the reference object corresponding to the reference image. For example, reference objects may be faces that the database recognizes as belonging to particular people. Database 110 may store data associating each reference image with a reference object. The reference images may belong to sets of reference images. Each set of reference images may correspond to a reference object. Reference image database 110 may conform the reference images so that the images all have the same dimensions and are in gray scale.

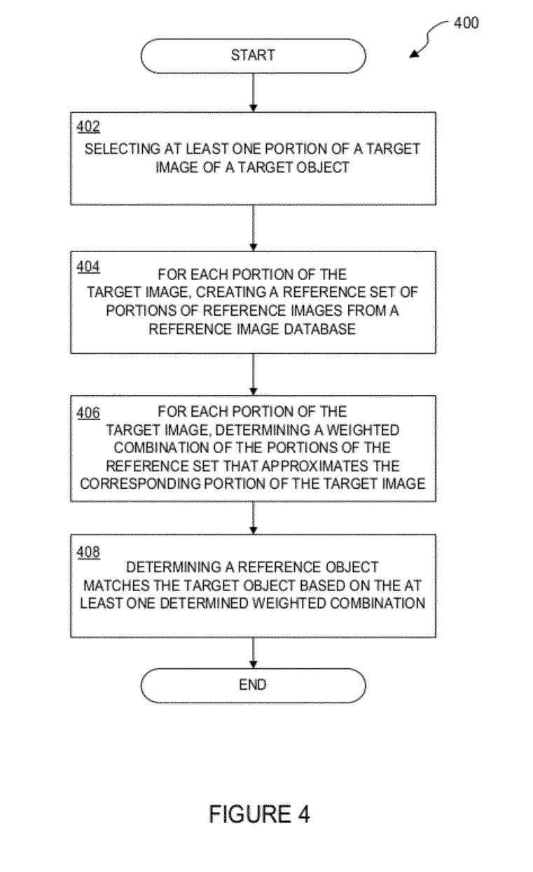

Reference set module 120 may generate a reference set based on the reference images in reference image database 110 and the portion of the target image selected by target image module 102. The reference set may be a collection of portions of the reference images selected by reference set module 120. The reference set generation is described below in regards to FIG. 4.

Weighted combination module 130 may determine a weighted combination of the portions of the reference images in the reference set that approximates the portion of the target image. The weighted combination may be a scalar which is multiplied by a vector from the reference set to approximate the portion of the target image. Determination of the weighted combination is described below in regards to FIG. 4.

Composite image module 140 may generate a composite image based on the weighted combination determined by weighted combination module 130. The composite image may be an image generated based on using only the values of the weighted combination for a single reference object. Composite image module 140 may also calculate the residual between the composite image and the portion of the target image. The residual may be the summation of the squares of the difference between each pixel of the composite image and the corresponding pixel of the portion of the target image.

Modules 102, 110, 120, 130, and 140 may be hardware modules which may be separate or integrated in various combinations. Modules 102, 110, 120, 130, and 140 may also be implemented by software stored on at least one tangible non-transitory computer readable medium.

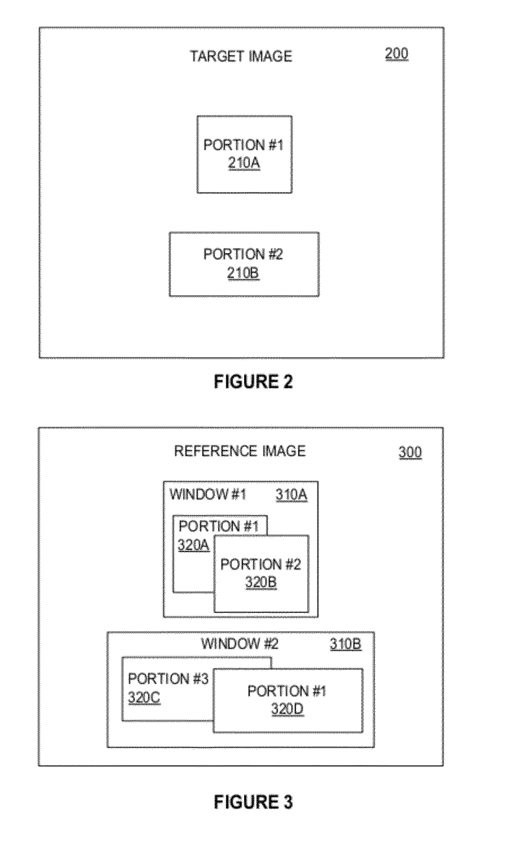

FIG. 2 illustrates exemplary target image 200 according to an embodiment of the current invention. Target image 200 may include first portion 210A and second portion 210B. Portions 210A, 210B may be blocks of adjacent pixels in target image 200. While in FIG. 2, portions 210A, 210B are not overlapping, portions 210A, 210B may partially overlap each other.

FIG. 3 illustrates exemplary reference image 300 according to an embodiment of the current invention. Reference image 300 may include first window portion 310A and second window portion 310B. Window portions 310A, 310B may be blocks of adjacent pixels in reference image 300. The dimensions of window portions 310A, 310B may define a search range within which portions 320A-D of the reference image may be selected. Portions 320A, 320B may correspond to portions within window portion 310A. Portions 320C, 320D may correspond to portions within window portion 310B. Portions 320A-D may be non-overlapping or partially overlapping.

FIG. 4 illustrates exemplary process flowchart 400 for determining a reference object matches a target object according to an embodiment of the current invention. Target image module 102 may select at least one portion of a target image of a target object (block 402). Target image module 102 may select portions randomly, by user input, or automatically. A user may specify the location and size of a portion, for example by using a mouse to outline a box around a potentially defining feature of the target object in the target image. A potentially defining feature may be a feature which may help distinguish the target object as a particular reference object. For example, a potentially defining feature may be an eye, nose, mouth, logo, etc. Target image module 102 may automatically analyze target image to identify a potentially defining feature. For example, target image module 102 may identify an eye in target image and select a portion to including the eye.

For each portion of the target image, reference set module 120 may create a reference set of portions of reference images from database 110 (block 404). Reference set module 120 may select window portions having dimensions larger than the dimensions of the selected portion of the target image, and within the window portions, select portions having the same dimensions of the selected portion of the target image.

Reference set module 120 may select window portions based on the location of a corresponding selected portion of a target image. For example, reference set module 120 may center a window portion at the same location as the center of the selected portion of the target image. The dimensions of window portions may also be determined based on the dimensions of the selected portion of the target image. For example, the dimensions of the window portions may be three times the dimensions of the selected portion of the target image.

Reference set module 120 may include all unique portions within the window portions in all reference images in database 110 or may not include all unique portions within the window portions in all reference images in database 110. Reference set module 120 may skip particular portions of window portions, skip entire reference images, or skip entire sets of reference images. For example, reference set module 120 may know that the target object is the face of a male and may exclude all sets of reference images that correspond with a reference object that is a face of a female.

For each portion of the target image, weighted combination module 130 may determine a weighted combination of the portions of the reference set that approximates the corresponding portion of the target image (block 406). Weighted combination module 130 may algorithmically determine the closest approximation of the portion of the target image. For example, weighted combination module 130 may utilize sparse representation to calculate the best approximation to the portion of the target image using a weighted combination of the portions of the reference images in the reference set.

Composite image module 140 may determine a reference object matches the target object in the target image based on the at least one weighted combination (block 408). Composite image module 140 may determine the composite image that has the smallest residual and determine that the reference object that the composite image corresponds to matches the target object if the residual is less than a residual threshold. The residual threshold may define the maximum residual that a composite image and a portion of a target image may have while still being considered as matching. In the case where there are multiple portions of the target image selected, and thus multiple reference sets, multiple weighted combinations, multiple composite images, and multiple residuals, composite image module 140 may determine a reference object matches the target object based on the multiple weighted combinations.

In one example, composite image may determine the reference object of the composite image that best matches each portion of the target image, and then determine the reference object which matches most portions matches the target object.

In another example, composite image may determine the individual probabilities that each composite image matches each selected portion of the target image. The probability may be determined based on an inverse proportion of the fitting error of the composite image. Composite image module 140 may then calculate the joint probability that each composite image matches all selected portions of the target image. The joint probability may be calculated by multiplying the individual probabilities that correspond to each reference object together. Composite image module 140 may then determine the reference object with the highest joint probability matches the target object if the joint probability is higher than a probability threshold. The probability threshold may define the lowest joint probability where a reference object may still be considered as matching a target object.

If composite image module 140 determines the target image does not match any reference objects, system 100 may associate the target image with a new reference object and store the target image and corresponding information for the new reference object in database 110.

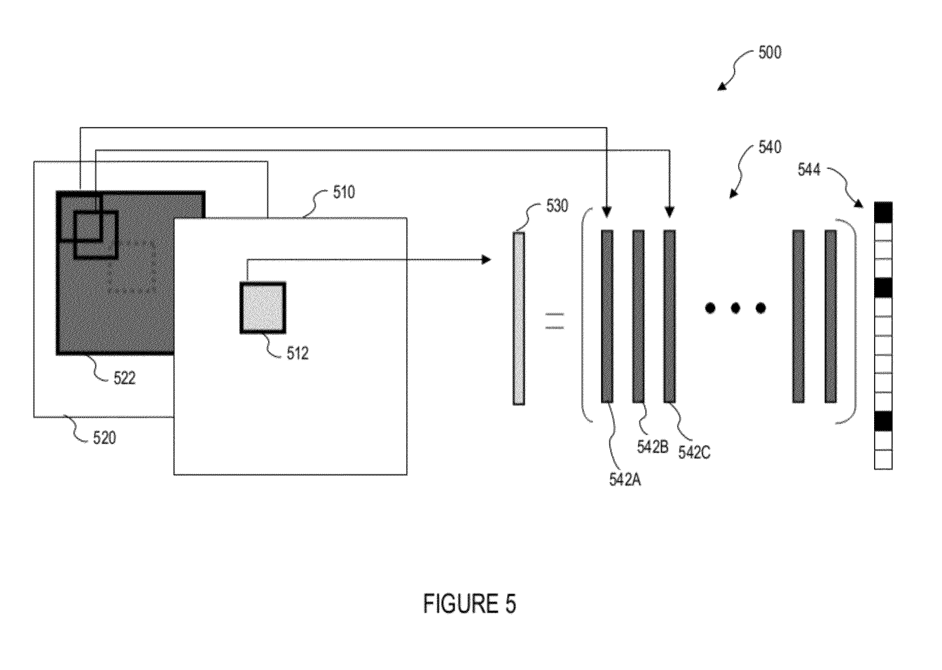

FIG. 5 illustrates diagram 500 of how to determine a weighted combination of portions in a reference set that approximates a corresponding portion of a target image according to an embodiment of the current invention. Portion 512 of target image 510 may be converted into vector 530 where each pixel within portion 512 may correspond with an element of vector 530. The pixels may be converted from left to right in portion 512, and then top to bottom, so that the first element in vector 530 corresponds with the pixel in the top left corner of portion 512 and the last element in vector 530 corresponds with the pixel in the bottom right corner of portion 512.

Portions within window portion 522 in reference image 520 may be similarly converted into vectors 542A, 542B, etc., where each vector may correspond with a portion within window portion 522. Vectors 542A, 542B, etc., may represent columns in array 540 which may represent a reference set.

Weighted combination module 130 may solve for scalar 544 resulting in the smallest residual between vector 530 and the product of array 540 and scalar 544.

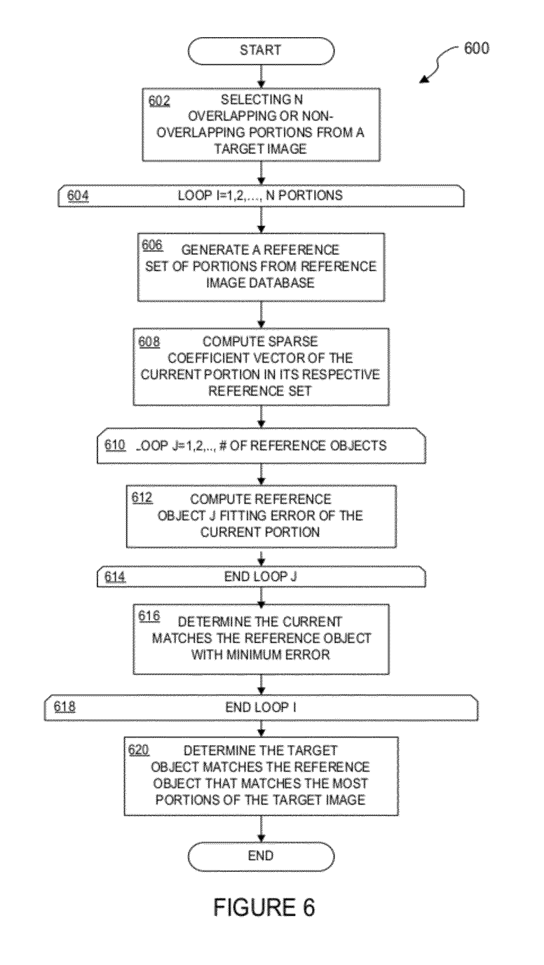

FIG. 6 illustrates exemplary process flowchart 600 for determining a target object matches a reference object based on frequency matching according to an embodiment of the current invention. Target image module 102 may select N overlapping or non-overlapping portions from a target image, where N represents a positive integer (block 602). Target image module 102 may do so as previously described in regards to block 402 of FIG. 4. For each of the portions, process may perform a loop beginning at block 604 and ending at block 618.

Within the loop, reference set module 120 may generate a reference set for a current portion (block 606). Reference set module 120 may do so as previously described in regards to block 404 of FIG. 4.

Weighted combination module 130 may compute a sparse coefficient vector of the current portion in its respective reference set (block 608). A sparse coefficient vector may represent a vector whose all entries, except for a few ones, are zero or insignificant. A sparse coefficient vector of the current portion in its respective reference set may be computed using popular sparse recovery algorithms such as Orthogonal Matching Pursuit or Basis Pursuit or their variants.

Using the sparse coefficient vector, composite image module 140 may calculate a reference object fitting error of the current portion for each reference object (block 610, block 612, and block loop 614). The reference object fitting error may be the residual between a composite image generated based on the values of the sparse coefficient vector that correspond with the reference object and the current portion.

Using the reference object fitting errors, composite image module 140 may determine the current portion matches the reference object that has the minimal fitting error out of all the reference object fitting errors (block 616).

After each portion is matched with a reference object, the loop may end (block 618).

Composite image module 140 may determine the target image matches the reference object that matches the most portions of the target image (block 620).

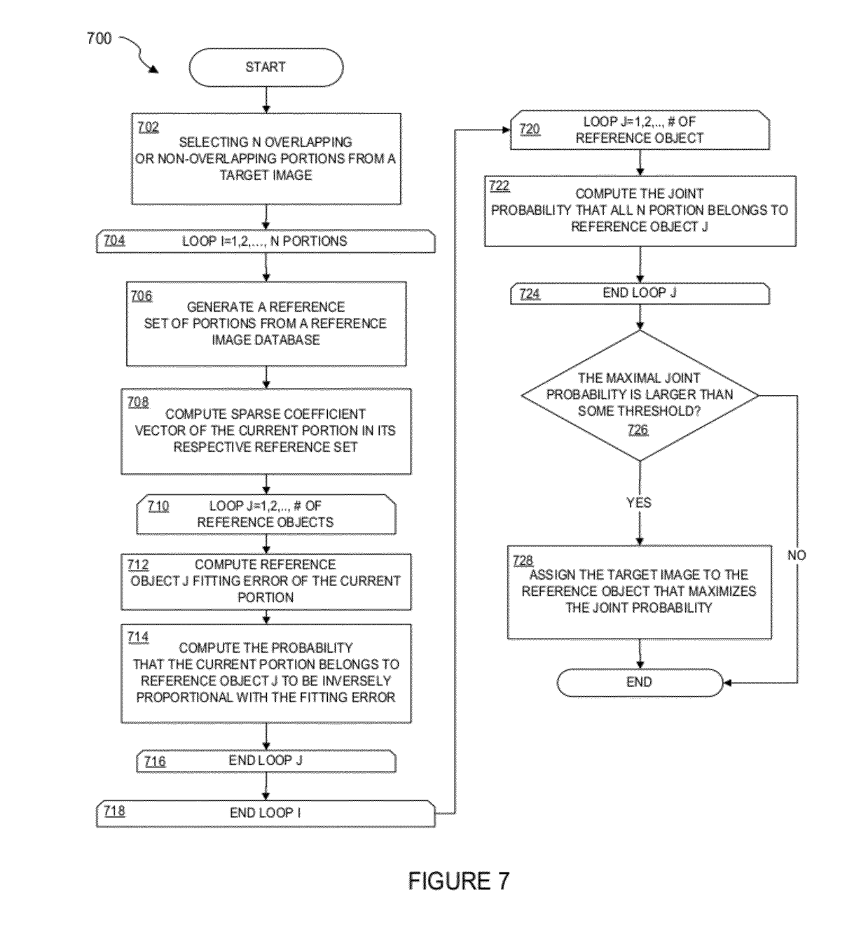

FIG. 7 illustrates exemplary process flowchart 700 for determining a target object matches a reference object based on probability matching according to an embodiment of the current invention. Target image module 102 may select N overlapping or non-overlapping portions from a target image, where N represents a positive integer (block 702). Target image module 102 may do so as previously described in regards to block 402 of FIG. 4. For each of the portions, process may perform a loop beginning at block 704 and ending at block 718.

Within the loop, reference set module 120 may generate a reference set for a current portion (block 706). Reference set module 120 may do so as previously described in regards to block 404 of FIG. 4.

Weighted combination module 130 may compute a sparse coefficient vector of the current portion in its respective reference set (block 708).

Using the sparse coefficient vector, composite image module 140 may perform a loop beginning at block 710 and ending at block 716. In the loop, for each reference object, composite image module 140 may compute a reference object fitting error of the current portion for each reference object (block 712) and compute the probability that the current portion matches the reference object (block 714). The probability may be computed to be inversely proportional with the computed fitting error.

Using the computed probabilities that each reference object matches each portion of the target image, composite image module 140 may compute the joint probability that all portions of the target image belong to each reference object (blocks 720, 722, 724). Composite image module 140 may compute the joint probability for each reference object by multiplying all the corresponding individual probabilities for each reference object.

Composite image module 140 may determine the maximal joint probability and determine if the maximal joint probability is larger than some threshold (block 726). If the maximal joint probability is larger than the threshold, composite image module 140 may determine the target image matches the reference object with the maximal joint probability (block 728). On the other hand, if the maximal joint probability is less than the threshold, composite image module 140 may determine the target image does not match any reference object.

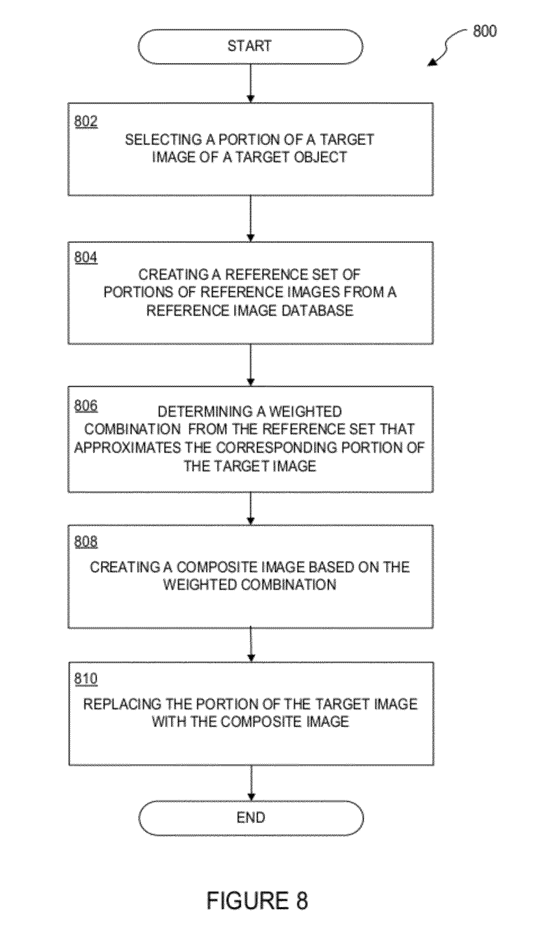

FIG. 8 illustrates exemplary process flowchart 800 for modifying a target image according to an embodiment of the current invention. The process shown in flowchart 800 may be used to remove noise, distortions, etc., from an image by replacing portions of the image with approximations of the portion from a weighted combination of portions of reference images within reference image database 110.

Initial blocks 802, 804, 806, and 808 of flowchart 800 may substantially correspond with initial blocks 402, 404, 406, and 408 of flowchart 400 for determining a reference object matches a target object, with the difference that only a single portion of the target image is selected in flowchart 800.

At block 810, instead of determining a reference object matches the target object as in block 410 of flowchart 400, composite image module 140 may replace the selected portion of the target image with the composite image (block 810).

### EXAMPLES

An example of system 100 uses a block-based face-recognition algorithm based on a sparse linear-regression subspace model via locally adaptive dictionary constructed from past observable data (training samples). A locally adaptive dictionary may be a reference set, past observable data may be reference images, and blocks may be portions of images.

The local features of the algorithm may provide an immediate benefit—the increase in robustness level to various registration errors. The approach is inspired by the way human beings often compare faces when presented with a tough decision: humans analyze a series of local discriminative features (do the eyes match? how about the nose? what about the chin? . . . ) and then make the final classification decision based on the fusion of local recognition results. In other words, the algorithm attempts to represent a block in an incoming test image as a linear combination of only a few atoms in a dictionary consisting of neighboring blocks in the same region across all training samples. The results of a series of these sparse local representations are used directly for recognition via either maximum likelihood fusion or a simple democratic majority voting scheme. Simulation results on standard face databases demonstrate the effectiveness of the algorithm in the presence of multiple mis-registration errors such as translation, rotation, and scaling.

A robust approach to deal with the misalignment problem is to adopt a local block-based sparsity model. The model is based on the observation that a block in a test image can be sparsely represented by neighboring blocks in the training images and the sparse representation encodes the block identity. In this approach, no explicit registration is required. The approach uses multiple blocks, classifies each block individually, and then combines the classification results for all blocks. In this way, instead of making a decision on one single global sparse representation, the decision relies on a combination of decisions from local sparse representations. This approach exploits the flexibility of the local block-based model and its ability to capture relatively stationary features under uniform and nonuniform variations, leading to a system robust to various types of misalignment.

### Block-Based Robust Face Recognition

First the original sparsity-based face recognition technique (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009) is briefly introduced. It is observed that a test sample can be expressed by a sparse linear combination of training samples

y=Dα,

where y is the vectorized test sample, columns of D are the vectorized training samples of all classes, and α is a sparse vector (i.e., only few entries in a are nonzero). The classifier seeks the sparsest representation by solving

\hat{α}₀=arg min ∥α∥₀ subject to Dα=y, (1)

where ∥•∥₀ denotes the l₀-norm which is defined as the number of nonzero entries in the vector. Once the sparse vector is recovered, the identity of y is then given by the minimal residual

$$identity ( y ) = arg {min}_{i} ‖ y - D {δ}_{i} ( {\hat{α}}_{0} ) ‖ , \qquad ( 2 )$$

where δᵢ (α) is a vector whose only nonzero entries are the same as those in α associated with class i. With the recently-developed theory of compressed sensing (E. Candès, J. Romberg, and T. Tao, “Robust uncertainty principles: Exact signal reconstruction from highly incomplete frequency information,” IEEE Trans. on Information Theory, vol. 52, no. 2, pp. 489-509, February 2006), the l₀-norm minimization problem (1) can be efficiently solved by recasting it as a linear programming problem. Alternatively, the problem in (1) can be solved by greedy pursuit algorithms (J. Tropp and A. Gilbert, “Signal recovery from random measurements via orthogonal matching pursuit,” IEEE Trans. on Information Theory, vol. 53, no. 12, pp. 4655-4666, December 2007) (W. Dai and O. Milenkovic, “Subspace pursuit for compressive sensing signal reconstruction,” IEEE Trans. on Information Theory, vol. 55, no. 5, pp. 2230-2249, May 2009).

As previously mentioned, the original technique (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009) does not address the problem of registration errors in the test data. In what follows, a robust approach is described to deal with misalignment by exploiting the flexibility of the local block-based model. Let K be the number of classes in the training data and Nₖ be the number of training samples in the kth class. The approach adopts the inter-frame sparsity model (T. T. Do, Y. Chen, D. T. Nguyen, N. H. Nguyen, L. Gan, and T. D. Tran, “Distributed compressed video sensing,” in Proc. of IEEE International Conference on Image Processing, November 2009) in which a block in a video frame can be sparsely represented by few neighboring blocks in reference frames.

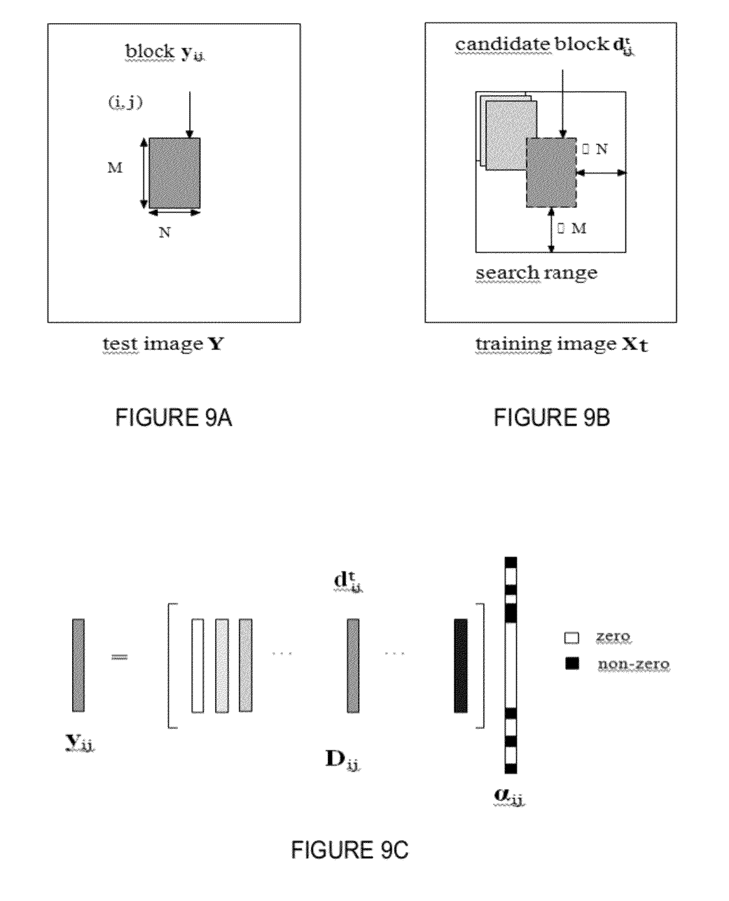

FIGS. 9A-9C illustrates an exemplary method of representing a block in a test face image Y from a locally adaptive dictionary according to an embodiment of the current invention. The locally adaptive dictionary consisting of neighboring blocks in the training images {Xₜ}_{t=1, . . . ,T} in the same physical area, where T=Σₖ₌₁^{K}Nₖ is the total number of training samples (only one training image is shown in FIGS. 9A-9C). FIG. 9A illustrates the blocks in the test and training images (only one training sample is displayed). To be more specific, let yᵢⱼ be an MN-dimensional vector representing the vectorized M×N block in the test image with the upper left pixel located at (i,j). Define the search region Sᵢⱼ^{t} be the (M+2ΔM)×(N+2ΔN) block in the tth training image Xₜ as:

$${S}_{ij}^{t} = [ \begin{matrix}{x}_{i - Δ M , j - Δ N}^{t} & … & {x}_{i - Δ M , j + N - 1 + Δ N}^{t} \\ ⋮ & ⋱ & ⋮ \\ {x}_{i + M - 1 + Δ M , j - Δ N}^{t} & … & {x}_{i + M - 1 + Δ M , j + N - 1 + Δ N}^{t}\end{matrix} ] .$$

From the search regions of all T training images, construct the dictionary Dᵢⱼ for the block yᵢⱼ as

Dᵢⱼ=[Dᵢⱼ¹Dᵢⱼ² . . . Dᵢⱼ^{T}],

where each

Dᵢⱼ^{t}=[d_{i-ΔM,j-ΔN}d_{i-ΔM,j-ΔN+1}^{t} . . . d_{i+ΔM,j+ΔN}^{t}]

is a (MN)×((2ΔM+1)(2ΔN+1)) matrix whose columns are the vectorized blocks in the tth training image defined in the same way as yᵢⱼ. The dictionary Dᵢⱼ is locally adaptive and changes from block to block. The size of the dictionary depends on the non-stationary behavior of the data as well as the level of computational complexity that can be afforded. In the presence of registration error, the test image Y may no longer lie in the subspace spanned by the training samples {Xₜ}ₜ. At the block level, however, yᵢⱼ can still be approximate by the blocks in the training samples {dᵢⱼ^{t}}_{t,i,j}. Compared to the original approach, the dictionary Dᵢⱼ better captures the local characteristics. This approach is quite different from patch-based dictionary learning (M. Elad and M. Aharon, “Image denoising via sparse and redundant representations over learned dictionaries,” IEEE Trans. on Image Processing, vol. 15, no. 12, pp. 3736-3745, December 2006) from several angles: (i) emphasis on the local adaptivity of the dictionaries; and (ii) dictionaries directly obtained from the data without any complicated learning process.

FIG. 9C illustrates a sparse representation yᵢⱼ=Dᵢⱼαᵢⱼ. In the approach block yᵢⱼ in the misaligned image Y can be sparsely approximated by a linear combination of a few atoms in the dictionary Dᵢⱼ:

yᵢⱼ=Dᵢⱼαᵢⱼ, (3)

where αᵢⱼ is sparse vector, as illustrated in FIG. 9C. The sparse vector can be recovered by solving the minimal l₀-norm problem

\hat{α}ᵢⱼ=arg min ∥αᵢⱼ∥₀ subject to Dᵢⱼαᵢⱼ=yᵢⱼ. (4)

Since sparse recovery is performed on a small block of data with a modest size dictionary, the resulting complexity of the overall algorithm is manageable. After the sparse vector \hat{α}ᵢⱼ is obtained, the identity of the test block can be determined by the error residuals by

$$identity ( {y}_{ij} ) = arg {min}_{k = 1 , … , K} {‖ {y}_{ij} - {D}_{ij} {δ}_{k} ( {\hat{α}}_{ij} ) ‖}_{2} , \qquad ( 5 )$$

where δₖ(\hat{α}ᵢⱼ) is as defined in (2).

To improve the robustness, the approach can employ multiple blocks, classify each block individually, and then combine the classification results. The blocks may be chosen completely at random, or manually in the more representative areas (such as the region around eyes) or areas with high SNR, or exhaustively in the entire test image (non-overlapped or overlapped). Since each block is handled independently, they can be processed in parallel. Also, since blocks can be overlapped, the algorithm is computationally scalable, meaning more computation delivers better recognition result.

Once the recognition results are obtained for all blocks, they can be combined by majority voting. Let L be the number of blocks in the test image Y, and {yₗ}_{l=1, . . . , L} be the L blocks. Then, by majority voting

$$identity ( Y ) = {max}_{k = 1 , … , K} \vert \{ l = 1 , … , L : identity ( {y}_{l} ) = k \} \vert ,$$

where ∥S∥ denotes the cardinality of a set S and identity(yₗ) is determined by (5).

Maximum likelihood is an alternative way to fuse the classification results from multiple blocks. For a block yₗ, its sparse representation \hat{α}ₗ obtained by solving (4), and the local dictionary Dₗ, define the probability of yₗ belonging to the kth class to be inversely proportional to the residual associated with the dictionary atoms in the kth class:

$${p}_{l}^{k} = P ( identity ( {y}_{l} ) = k ) = \frac{1 / {r}_{l}^{k}}{{\sum }_{k = 1}^{K} ( 1 / {r}_{l}^{k} )} , \qquad ( 6 )$$

where rₗ^{k}=∥yₗ−Dₗδₖ(\hat{α}ₗ)∥₂ is the residual associated with the kth class and the vector δₖ (\hat{α}ₗ) is as defined in (5). Then, the identity of the test image Y is given by

$$identity ( Y ) = arg {max}_{k = 1 , … , K} log ( {\prod }_{l = 1}^{L} {p}_{l}^{k} ) . \qquad ( 7 )$$

The maximum likelihood approach can also be used as a measure to reject outliers, as for an outlier the probability of it belonging to some class tends to be uniformly distributed among all classes in the training data.

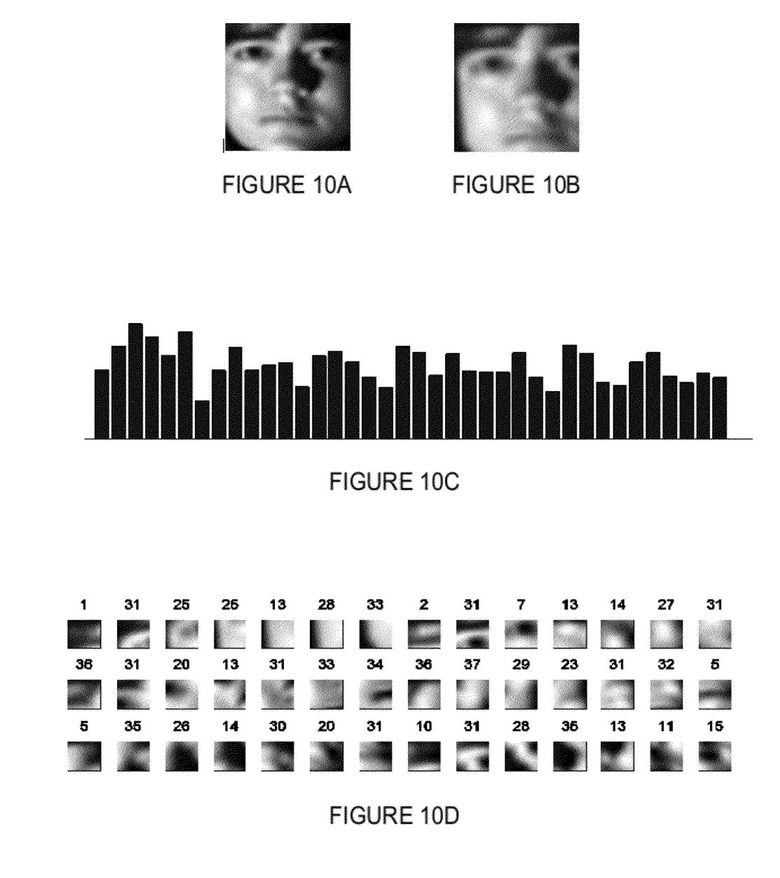

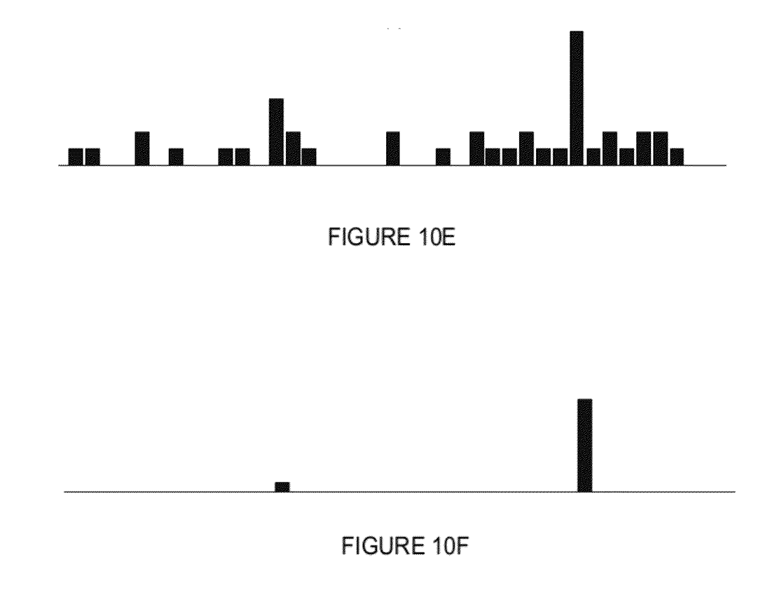

FIGS. 10A-10F illustrates an exemplary method of matching using multiple blocks in a test image according to an embodiment of the current invention. The test and training images are taken from the Extended Yale B Database (A. S. Georghiades, P. N. Belhumeur, and D. J. Kriegman, “From few to many: Illumination cone models for face recognition under variable lighting and pose,” IEEE Trans. on Pattern Analysis and Machine Intelligence, vol. 23, no. 6, pp. 643-660, June 2001) which consists of face images of 38 individuals. More details about this database and the setup will be described in the next section.

FIG. 10A shows the original (registered) image in the 31st class, and FIG. 10B shows the test image to be classified, which is obtained by translating the original one by 3 pixels in each direction, rotating by 4 degrees, and then zooming in by a scaling factor of 1.125 in the vertical direction and 1.143 in the horizontal direction. Due to the misalignment, the original global approach in (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009) leads to misclassification, as seen by the residuals in FIG. 10C, which shows the residuals using the original global approach, where the 7th class has the minimal residual.

Using the approach, 42 blocks of size 8×8 uniformly are chosen from the test image in FIG. 10B. The blocks and classification result for each individual block are displayed in FIG. 10D. FIG. 10E shows the number of votes for each of the k classes using a majority voting approach and FIG. 10F show the probability that each class matches the test image using a maximum likelihood approach. In both cases, the block-based algorithm yields the correct answer of class 31.

The above example illustrates the process of the block-based algorithm in the presence of registration errors. When the errors become more significant, the local dictionary may also be augmented by including distorted versions of the local blocks in the training data for a better performance, at the cost of higher computational complexity.

### Simulation Results

In this section, the block-based algorithm is applied for identification on a publicly available database—the Extended Yale B Database (A. S. Georghiades, P. N. Belhumeur, and D. J. Kriegman, “From few to many: Illumination cone models for face recognition under variable lighting and pose,” IEEE Trans. on Pattern Analysis and Machine Intelligence, vol. 23, no. 6, pp. 643-660, June 2001), and comparison of the performance with the original algorithm in (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009). This database consists of 2414 perfectly-aligned frontal face images of size 192×168 of 38 individuals, 64 images per individual, under various conditions of illumination. For each subject, randomly choose 15 images in Subsets 1 and 2, which were taken under less extreme lighting conditions, as the training data. Then, randomly choose 500 images from the remaining images as test data. All training and test samples are downsampled to size 32×28. The Subspace Pursuit algorithm (W. Dai and O. Milenkovic, “Subspace pursuit for compressive sensing signal reconstruction,” IEEE Trans. on Information Theory, vol. 55, no. 5, pp. 2230-2249, May 2009) is used to solve the sparse recovery problem (4).

To verify the effectiveness of the algorithm under registration errors, create distorted test images in several ways and keep the training images unchanged. The algorithm is robust to image translation by choosing an appropriate search region for each block such that the corresponding blocks in the training images are included in the dictionary. Next, show results for test images under rotation and scaling operations.

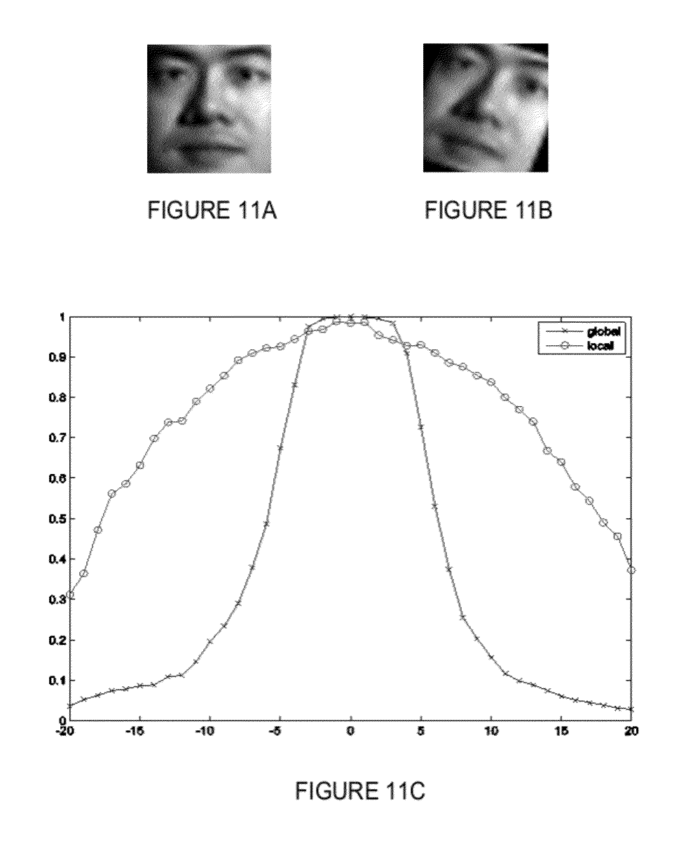

FIGS. 11A and 11B illustrate an exemplary original test image and an exemplary distorted test image according to an embodiment of the current invention. In the first set, the test images are rotated by degrees between −20 and 20, as seen by the example in FIGS. 11A and B where FIG. 11A shows the original image and FIG. 11B shows the original image rotated by 20 degrees clockwise.

Apply the block-based algorithm to 42 blocks of size 8×8 uniformly located on the test image, and the results are combined using the maximum likelihood approach (6).

FIG. 11C illustrates an exemplary graph of the recognition rate (y-axis) for each rotation degree (x-axis) according to an embodiment of the current invention. It can be seen that at a higher level of misalignment, the block-based algorithm (circles) outperforms the original algorithm (x-marks) by a large margin.

For the second set, the test images are stretched in both directions by scaling factors up to 1.313 vertically and 1.357 horizontally.

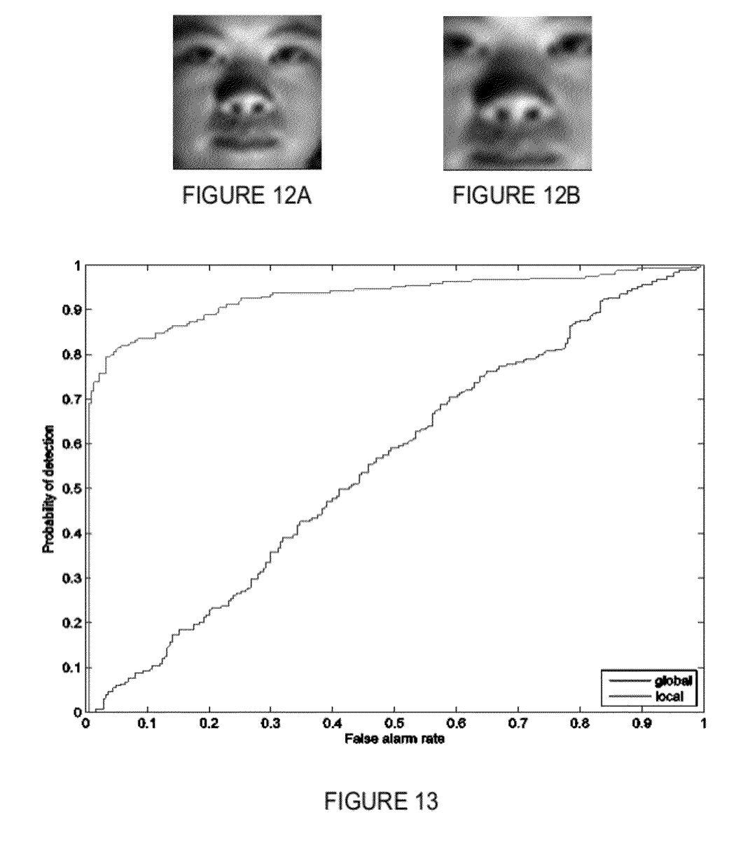

FIGS. 12A and 12B illustrate another exemplary original test image and an exemplary distorted test image according to an embodiment of the current invention. FIG. 12B shows the image of FIG. 12A scaled by 1.313 vertically and 1.357 horizontally.

Similar to the previous case, for each test image, apply the algorithm to 42 uniformly-located blocks of size 8×8 and combine the results by (6). Tables 1 and 2 show the percentage of correct identification out of 500 tests with various scaling factors. The first row and the first column in the tables indicate the scaling factors in the horizontal and vertical directions, respectively, and the other entries correspond to the recognition rate in percentage. Again, when there are large registration errors, the block-based algorithm leads to a better identification performance than the original algorithm.

1. Recognition rate (in percentage) for scaled test images using the original global approach under various scaling factors (SF).

| SF | 1 | 1.071 | 1.143 | 1.214 | 1.286 | 1.357 |
|---|---|---|---|---|---|---|
| 1 | 100 | 100 | 94.8 | 71.4 | 51.8 | 41.4 |
| 1.063 | 99.2 | 95.0 | 76.6 | 51.8 | 33.8 | 28.6 |
| 1.125 | 84.6 | 66.4 | 42.6 | 25.2 | 18.6 | 14.6 |
| 1.188 | 52 | 37.2 | 20.6 | 15.6 | 11.6 | 8 |
| 1.25 | 33.2 | 26.4 | 16.8 | 11.4 | 9.4 | 7.6 |
| 1.313 | 33.6 | 22.6 | 14.6 | 10.6 | 7.4 | 7.6 |

2. Recognition rate (in percentage) for scaled test images using the block-based approach under various SF.

| SF | 1 | 1.071 | 1.143 | 1.214 | 1.286 | 1.357 |
|---|---|---|---|---|---|---|
| 1 | 98 | 96.4 | 97.6 | 96.4 | 96.4 | 95.2 |
| 1.063 | 97.4 | 96.6 | 96.6 | 95.6 | 92.4 | 90 |
| 1.125 | 97 | 95.4 | 94.6 | 94.6 | 92.6 | 90.2 |
| 1.188 | 95 | 94 | 91.8 | 90.2 | 85.6 | 82.2 |
| 1.25 | 93.8 | 92.4 | 89 | 85 | 79.4 | 73.6 |
| 1.313 | 88.8 | 85 | 79 | 75.8 | 67 | 59.2 |

In the last set, the 500 test images are shifted by 3 pixels downwards and rightwards (about 10% of the side lengths), rotated by 4 degrees counterclockwise, and then zoomed in by 1.125 and 1.143 in vertical and horizontal directions, respectively. One example of the misaligned test images is shown in FIGS. 10A and 10B. In this case of combined misalignment, the original approach only successfully identifies 20 out of 500 test images, while the block-based algorithm yields an identification rate of 82% (i.e., 410 out of 500 are correctly recognized).

### Outlier Rejection

In this set, only samples in 19 out of the 38 classes are included in the training set, and the other 19 objects become outliers. Similar to the previous sets, 15 samples per class from Subsets 1 and 2 are used for training (19×15=285 samples in total). There are 500 test samples, among which 250 are inliers and the other 250 are outliers, and all of the test samples are rotated by five degrees. For each test sample, in the local approach, 42 blocks of size 8×8 are used, then calculate

$${P}_{ma x} = {max}_{k = 1 , … , K} log ( {\prod }_{l = 1}^{L} {p}_{l}^{k} ) , \qquad ( 8 )$$

where pₗ^{k} is defined in (6). If Pₘₐₓ<δ for some thresholdδ, then the test sample will be rejected as an outlier. In the global approach, the Sparsity Concentration Index (J. Wright, A. Y. Yang, A. Ganesh, S. Sastry, and Y. Ma, “Robust face recognition via sparse representation,” IEEE Trans. on Pattern Analysis and Machine Intelligence, vol. 31, no. 2, pp. 210-227, February 2009) is used as the criterion for outlier rejection.

FIG. 13 illustrates receiver operating characteristic (ROC) curves according to an embodiment of the current invention. FIG. 13 shows curves for both approaches, where the probability of detection is the ratio between the number of detected inliers and the total number of inliers and the false alarm rate is computed by the number of outliers which are detected as inliers divided by the total number of outliers. The probability in (8) can be used as an outlier rejection criterion.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A method of identifying an object in an image, comprising:
selecting a portion of a target image of a target object;
selecting a corresponding window portion of a reference image of a reference object from at least one reference image of at least one reference object, the position of the window portion within the reference image corresponding to the position of the portion of the target image within the target image;
generating a reference set comprising a plurality of different portions of the reference image from within the window portion;
determining a weighted combination of the plurality of different portions from the reference set approximating the portion of the target image; and
determining whether the target object matches the reference object based on the weighted combination.

2. The method of claim 1, wherein determining the weighted combination comprises calculating a sparse representation for the portion of the target image from the plurality of different portions from the reference set.

3. The method of claim 1, wherein determining whether the target object matches comprises:
determining a residual between the portion of the target image and a composite image based on the weighted combination; and
determining the residual is less than a threshold.

4. The method of claim 1, wherein the window portion of the reference image has dimensions larger than the dimensions of the portion of the target image;

5. The method of claim 1, further comprising:
selecting a second corresponding window portion of a second reference image of the reference object, the position of the second window portion within the second reference image corresponding to the position of the portion of the target image within the target image;
wherein the reference set further comprises a plurality of different portions of the second reference image from within the second window portion.

6. The method of claim 1, further comprising:
selecting a second corresponding window portion of a second reference image of a second reference object, the position of the second window portion within the second reference image corresponding to the position of the portion of the target image within the target image;
wherein the reference set further comprises a plurality of different portions of the second reference image from within the second window portion.

7. The method of claim 6, further comprising:
determining a residual between the portion of the target image and a composite image from the portions of the reference object based on the weighted combination;
determining a second residual between the portion of the target image and a composite image from the portions of the second reference object based on the weighted combination; and
determining whether the target object matches the reference object comprises determining the residual is less than the second residual.

8. The method of claim 1, further comprising:
selecting a second portion of a target image of a target object;
selecting a second corresponding window portion of the reference image of the reference object, the position of the second window portion within the reference image corresponding to the position of the portion of the target image within the target image;
generating a second reference set comprising a plurality of different portions of the reference image from within the window portion;
determining a second weighted combination of the plurality of different portions from the second reference set approximating the portion of the target image; and
wherein determining whether the target object matches the reference object is further based on the second weighted combination.

9. The method of claim 8, wherein determining whether the target object matches the reference object comprises:
computing a probability the portion of the target image matches a composite image from the portions of the reference object based on the weighted combination;
computing a second probability the second portion of the target image matches a second composite image from the portions of the reference object based on the second weighted combination;
computing a joint probability the target object matches the reference object based on the probability and the second probability; and
determining the joint probability is greater than a threshold.

10. A tangible machine readable storage medium that provides instructions, which when executed by a computing platform, cause said computing platform to perform operations comprising a method of identifying an object in an image, comprising:
selecting a portion of a target image of a target object;
selecting a corresponding window portion of a reference image of a reference object from at least one reference image of at least one reference object, the position of the window portion within the reference image corresponding to the position of the portion of the target image within the target image;
generating a reference set comprising a plurality of different portions of the reference image from within the window portion;
determining a weighted combination of the plurality of different portions from the reference set approximating the portion of the target image; and
determining whether the target object matches the reference object based on the weighted combination.

11. A method of modifying an image of an object, comprising:
selecting a portion of a target image of a target object;
selecting a corresponding window portion of a reference image of a reference object from at least one reference image of at least one reference object, the position of the window portion within the reference image corresponding to the position of the portion of the target image within the target image;
generating a reference set comprising a plurality of different portions of the reference image from within the window portion;
determining a weighted combination of the plurality of different portions from the reference set approximating the portion of the target image; and
replacing the portion of the target image with a composite image from the different portions from the reference set based on the weighted combination.
